(19) United States
(12) Patent Application Publication
(10) Pub. No.: US 2008/0217036 A1
(43) Pub. Date: Sep. 11, 2008

(54) Pneumatically actuated skidplates for an earth-moving scraper

(76) Inventor: Mark R. Miskin, Alta, WY (US)

Correspondence Address: MORRISS OBRYANT COMPAGNI, P.C., 734 EAST 200 SOUTH, SALT LAKE CITY, UT, 84102, US

(21) Appl. No.: 11/713,934

(22) Filed: Mar. 5, 2007

(51) Int. Cl. A01B 35/32

(52) U.S. Cl. 172/776

(57) ABSTRACT

Apparatus, systems and methods for the stabilization of an earth-moving apparatus, such as an earth-moving scraper. A skidplate is attached to the earth-mover by one or more inflatable airbags, such as a pneumatic suspension air-spring, which may be inflated to lower the skidplate into contact with the ground surface. The skidplate (or a skid shoe attached thereto) remains held firmly on the ground regardless of minor adjustments to the blade height, due to the “springiness” of the air bag. The skidplate can be retracted when use is not desired, by deflation of the air bags. One or more motion sensors and a control unit may be included, allowing bounce to be detected before it is visible to the operator. The control unit may cause the airbags to inflate as needed to stabilize the earth-moving apparatus.

### TECHNICAL FIELD

The present invention relates generally to land-leveling scrapers and apparatus for modifying the earth's surface by removing soil from the earth's surface at one location and moving the soil to a new location. More specifically, the present invention relates to earth moving apparatus, such as scrapers, that include skidplates or skid shoes which engage the ground surface to stabilize the earth moving apparatus and lessen the tendency of the cutting blade to dig unevenly without substantially affecting the desired grade.

### BACKGROUND

Scrapers and other earth moving apparatus of the general type to which the present invention relates are known. Representative examples of earth moving scrapers include, without limitation, those scrapers disclosed in U.S. Pat. Nos. 4,383,380, 4,388,769, 4,398,363, 4,553,608, 6,347,670, and 6,845,824 to Miskin, each of which is incorporated by reference in its entirety. A typical scraper includes a frame having a front end, two opposing sides and at least two wheels connected to the opposing sides. A bucket for holding soil removed from the earth is connected to the frame. The bucket may include a floor, two opposing side walls, an open front and an open top. A blade is located adjacent the front edge of the floor of the bucket for cutting the earth to a predetermined depth as the earth moving apparatus is moved forward over the earth's surface. The soil cut from the earth by the blade is collected in the bucket.

Soil may be removed from the bucket of the scrapers in different ways. For instance, moving back scrapers, sweep scrapers, open bottom dump scrapers and dump scrapers are known. For instance, an ejector scraper has a moving wall or ejector assembly which pushes the soil out of the bucket. An example of an ejector scraper is disclosed in U.S. Pat. No. 6,041,528 assigned to Harvey Mfg. Corp., which is incorporated by reference in its entirety herein. An example of a sweep scraper is an elevating type scraper that discharges soil collected in the bucket by moving members, or slats, across of the floor of the bucket. An exemplary sweep scraper is disclosed in U.S. Pat. No. 3,934,360 assigned to Westinghouse Air Brake Company, which is incorporated by reference in its entirety herein. In an open bottom dump scraper, the bucket of the scraper is tilted to dump the soil out of an open end of the bucket. Examples of pull-type, bottom dump scrapers include construction scrapers disclosed in U.S. Pat. Nos. 4,383,380, 4,388,769, 4,398,363, 4,553,608 and 6,347,670 to Miskin, discussed previously herein. Other scrapers, such as “open bottom” scrapers may lack a bucket and simply include a frame or an elongated pole having an earth moving blade attached thereto which is used to cut and level soil.

A pull-type scraper or earth moving apparatus may have an elongated tongue attached to a frame. The tongue may be connected to a tractor that tows the scraper or the earth moving apparatus. The tongue may be connected to a tractor with a hitch or may include a so-called rigid, gooseneck that pivots and is attached to the tractor. Alternatively, the scraper may include a front set of “dolly” wheels or may be attached to a separate dolly that attaches to a tractor. Other scrapers or other earth moving apparatuses are self-propelled.

When the scraper or earth moving apparatus is moved forward over the surface of the earth and the blade is lowered, the blade cuts the soil and delivers the soil to the bucket. The soil travels over the upper surface of the blade and into the bucket. Scrapers may thus be used to accomplish ground leveling or grading. Similarly, ejecting soil from the bucket of a scraper ahead of the blade may be used to “fill in” low spots to achieve even leveling. During the process of ground leveling, the elevation of the cutting blade with respect to the ground surface may be adjusted by the operator raising or lowering the blade or the wheels of the scraper. Some scrapers implement laser surveying systems to achieve precise leveling of the ground surface.

While performing land leveling operations scrapers have been known to bounce, undulate from side-to-side, waddle and duck walk. These undesirable motions are particularly severe when scrapers travel at higher speeds. This can cause the cutting blade to dig unevenly into the ground surface, require additional leveling work to obtain a satisfactory ground surface, and accelerate wear and tear on the scraper components from additional vibration and cyclical loading, especially when the scraper is used for “skimming” (making shallow cuts or spreading thin amounts of unloaded soil).

Different solutions have been proposed to prevent or minimize these undesirable motions. U.S. Pat. No. 4,389,800 discloses a land leveling scraper which includes a skid shoe system where the bottom surface of the skid shoes are intended to accommodate and follow irregularities in the ground surface being leveled, and the skid shoes are urged against the ground surface with a force proportional to the load on the bucket of the scraper. Such force is to be applied by a hydraulic cylinder. However, this type of skid shoe system is an integral part of the land leveling scraper as opposed to an easily installed after-market addition. Moreover, this system operates on the same hydraulics which lower and raise the bucket and thus is not independently adjustable by the operator to allow custom settings for different earth removal applications, such as digging a sump as opposed to obtaining precise leveling of the ground surface. Finally, because this system is connected to other dirt bucket hydraulics, blade and bucket reaction times are slower and the system can be difficult to maintain.

Another attempted solution has been to add additional axles and wheels to the back of the scraper. However, this solution is expensive, requires additional maintenance, and may prevent running scrapers in tandem as the additional axles and wheels interfere with installing the towing mechanism required for connecting additional scrapers.

U.S. Pat. No. 5,307,570 discloses the attachment of skid shoes to dirt buckets by spring-loaded legs. However, adjustment of the load-bearing capacity of the skid shoes requires changing of the coil compression spring. Even if the proper spring is available, the spring-loaded legs must be dismantled for installation of different springs. Additionally, such skid shoes are not easily retractable, and are thus almost always active. This leads to additional wear on the shoe and increases fuel consumption.

U.S. Pat. No. 6,289,614 attempted to address these shortcomings by attaching an after-market skid shoe to a pivot on the bottom of a scraper dirt bucket and using a hydraulic cylinder to extend a rear end of the shoe to the ground. Using an independent hydraulic system increases the maintenance required on the scraper and the pivoted skid shoe design limits the area of the skid shoe that could be in contact with the ground. Attempts to contact more of the shoe to the ground would either attempt to force the shoe further into the ground or exert a lift force on the scraper. The result is that the shoe is rigidly locked when the hydraulics are centered, and the shoes dig trenches, and wear out rapidly.

Thus, apparatus, systems and methods that provide skid shoes that make for greater or more effective contact with the ground to reduce bounce, which are easier to use or maintain, or capable of independent control would be an improvement in the art.

### SUMMARY

The present invention provides apparatus, systems and methods for the stabilization of an earth-moving apparatus, such as an earth-moving scraper. A skidplate is attached to the earth-mover by one or more inflatable airbags, such as a pneumatic suspension air-spring, which may be inflated to lower the skidplate into contact with the ground surface. The skidplate (or a skid shoe attached thereto) remains held firmly on the ground regardless of minor adjustments to the blade height, due to the “springiness” of the air bag). The skidplate can be retracted when use is not desired, by deflation of the air bags. Such a skidplate assembly may be offered as a separate unit for after-market installation on an earth-moving vehicle.

Systems in accordance with the present invention may also include one or more motion sensors and a control unit, which may be a computer. Using such a system, the bounce or “duckwalk” motion may be detected before it is visible to the operator. The control unit may cause the airbags to inflate as needed to stabilize the earth-moving apparatus, then deflate to minimize wear on the skidplate.

### DESCRIPTION OF THE DRAWINGS

It will be appreciated by those of ordinary skill in the art that the elements depicted in the various drawings are for exemplary purposes only. The nature of the present invention, including the best mode, as well as other embodiments of the present invention, may be more clearly understood by reference to the following detailed description of the invention, to the appended claims, and to the several drawings.

FIG. 1 is side view of one illustrative embodiment of an earth moving scraper including a stabilization control system in accordance with the present invention.

FIG. 2 is a top perspective view of an illustrative embodiment of another skidplate assembly in accordance with the present invention.

FIG. 3 is a schematic view of a stabilization system including at least one sensor and a control unit, in accordance with the present invention.

### DETAILED DESCRIPTION

The present invention relates to systems and methods for stabilizing an earth-moving machine during a cutting or scraping operation. It will be appreciated by those skilled in the art that the embodiments herein described, while illustrating certain embodiments, are not intended to so limit the invention or the scope of the appended claims. Those skilled in the art will also understand that various combinations or modifications of the embodiments presented herein can be made without departing from the scope of the invention. All such alternate embodiments are within the scope of the present invention. Similarly, while the drawings depict illustrative embodiments of devices and components in accordance with the present invention and illustrate the principles upon which the depicted device or component is based, they are only illustrative and any modification of the invented features presented herein are to be considered within the scope of this invention.

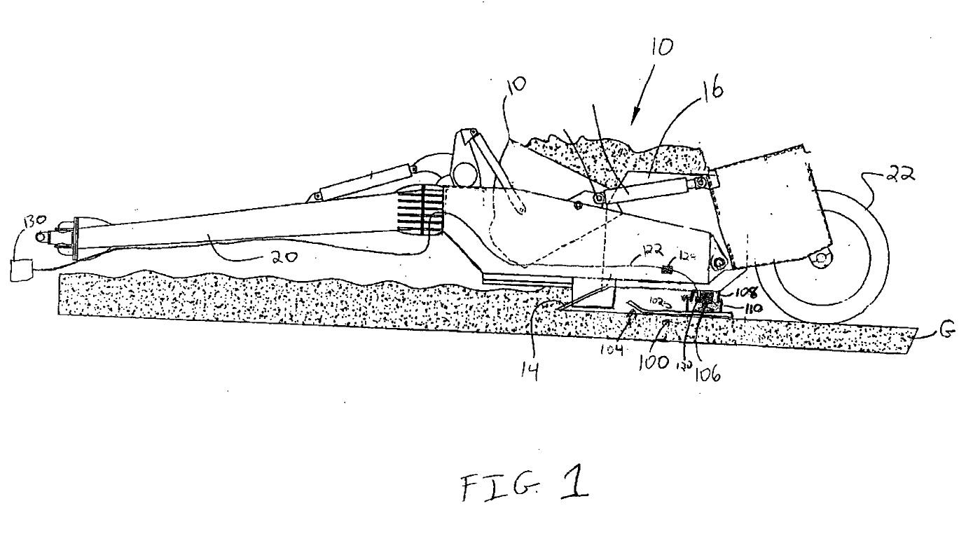

Turning to FIG. 1, in one illustrative embodiment, the earth-moving machine may be an earth-moving scraper 10. Representative examples of earth moving apparatus which may be used in conjunction with the stabilization systems of the present invention include, without limitation, the scrapers disclosed in U.S. Pat. Nos. 4,383,380, 4,388,769, 4,398,363, 4,553,608 and 6,347,670 to Miskin. It will be apparent that the stabilization systems of the present invention may be configured to be operatively connected to any pull-type scraper, self-propelled scraper, moving back scraper that includes a moving wall or ejector assembly in the bucket that pushes the soil out of the bucket, sweep scraper that includes at least one moving section of the floor of the bucket that transfers the soil out of the bucket, open bottom scraper or dump scraper that includes a bucket configured to tilt and dump the soil out of the bucket in addition to the disclosed in the Miskin patents.

As illustrated in drawing FIG. 1, the earth moving apparatus 10 includes a cutting blade 14, a bucket 16, an apron 18, a tongue 20 and ground engaging wheels, 22. The cutting blade 14 may be attached to a frame of the scraper 10 and be generally disposed laterally between the opposing sides of the scraper 10. In other embodiments, the blade 14 may be attached to the bucket 16 and it will be apparent that the blade 14 may be adjoined to the earth moving apparatus 10 in any manner known by those of ordinary skill in the art.

As depicted at 100 in FIG. 1, a skidplate, generally indicated at 100, may be attached to the underside of the earth moving apparatus. In the depicted embodiment, skidplate 100 is attached to a front loading, bucket tilting scraper, behind blade 14 and under the bucket 16 (when bucket 16 is in the lowered position). As depicted, skidplate 100 may be used to directly contact the ground surface G, although it will be appreciated that one or more skid shoes may be attached to the lower surface of the skidplate, such that the frictional wear is absorbed by the skid shoes.

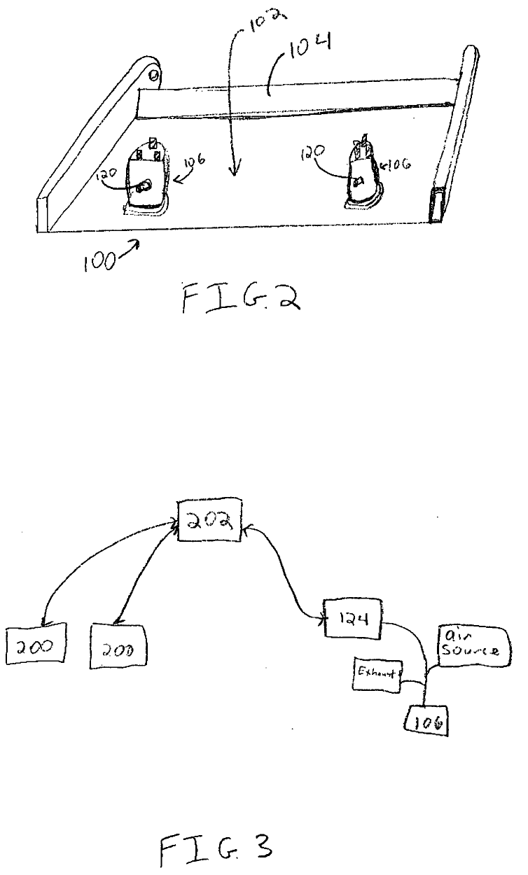

As best depicted in FIG. 2, the skidplate 100 may be a single plate that has a width similar to space between the left and right members of the scraper frame. It will be appreciated that the skidplate may be of any desired width, and that one or more narrower skidplates, each separately attached to the scraper, as discussed further herein, may be used.

In the depicted embodiment, the skidplate has an elongated planar midsection 102, which may be used to contact the ground G, and an upturned leading edge 104. The upturned leading edge 104 may act similar to the upturned edge of a ski, assisting in the movement of the skidplate 100 over the ground G by reducing the tendency of the edge to catch and dig into the ground G surface.

An embodiment similar to that depicted in FIGS. 1 and 2, where a generally ski-shaped skidplate 100 is used, such that the entire planar midsection of the body 102 may be used to contact the ground, resulting in maximization of the contact therebetween and the resulting reduction of bounce. However, it will be appreciated that embodiments, where the front or leading edge of the skidplate 100 is pivotally attached to the scraper body are contemplated and may be used within the cope of the present invention.

The skidplate 100 is attached to the scraper or other earth moving apparatus by one or more inflatable airbags 106. Inflatable airbag 106 may be an airspring, such as a reversible sleeve or a double convoluted airspring. Airsprings are airbags designed for used as springs in automotive, train, tractor-trailer, and other vehicular suspension systems. As depicted, typically, airsprings include a bellows attached to one or more plates. Physical connections may be made to the plates or the pistons of the airbags through connection bolts disposed therein. Currently, air springs are available in reversible sleeve (piston) and single, double or triple convoluted conformations, any of which may be used with embodiments of the present invention. Suitable airsprings are available from FIRESTONE and other suspension component manufacturers. These may be used in the present invention as well.

It will be appreciated that where each airbag 106 is an airspring, each may be considered a pneumatic spring configured as a column of gas (air) confined within a container. The pressure of the confined gas, and not the structure of the container, acts as the force medium of the spring. A wide variety of sizes and configurations of airsprings are available, including sleeve-type airsprings, bellows-type airsprings, convoluted-type airsprings, rolling lobe airsprings, etc. Such airsprings commonly are used in both vehicular and industrial applications. Airsprings, regardless of their size and configuration, share many common elements. In general, an airspring includes a flexible, sleeve-like member made of fabric-reinforced rubber that defines the sidewall of an inflatable container. Each end of the flexible member is closed by an enclosure element, such as a bead plate which is attached to the flexible member by crimping. The uppermost enclosure element typically also includes air supply components and mounting elements (e.g., studs, blind nuts, brackets, pins, etc.) to couple the airspring to the vehicle structure. The lowermost enclosure element also typically includes mounting elements to couple the airspring to the vehicle axle. Examples of airsprings are set forth and discussed in U.S. Pat. No. 6,957,806, the disclosure of which is incorporated by reference herein.

One end of pneumatic airbag 106 is secured to the skidplate 100, at a portion of planar midsection 102, typically towards the rear portion thereof. The other end of the pneumatic airbag 106 is attached to the earth moving apparatus 100. It may be attached directly to the scraper frame or to a suitable mounting plate or fitting attached thereto. In some embodiments a protective structure may be formed to encase airbag 106. For example, concentric metal rings 108 and 110 may be attached to the skidplate 100 and the scraper frame or the airbag mounting plate. Rings 108 and 110 may be slidably disposed over the other. As airbag 106 is inflated and deflated, rings 108 and 110 may slidably move with respect to one another, protecting the airbag 106 through continuous encasement. In such embodiments, the rings 108 and 110 may have channels or stops that interact with each other to provide a uniform pathway for the movement of skidplate 100 and to prevent over inflation of the airbag 106.

It will be appreciated that any number of airbags 100 may be used to attach a single wide skidplate 100 to the earth-moving apparatus 10. For example, a single airbag 106 may be useful for some embodiments, while two or more airbags, which may be evenly space across the lateral surface of the skidplate 100, may be used in other embodiments, as may be desired (and as shown in FIG. 2). For embodiments where multiple skidplates 100 are used, each may be separately attached to the scraper 10 by one or more individual airbags 106 attached thereto.

Attached to each airbag 106 is a fitting 120 to which an air hose 122 and a valve 124 may be functionally attached. There structures may be used to inflate the airbag 106. In some embodiments, a pressure gauge P may be attached to the line, allowing the pressure in the airbag 106 and air hose 122 to be monitored. Valve 124 may include an exhaust, or a separate exhaust may be included for deflation of the bag.

The air hose 122 is attached to a gas source 130, such as an air compressor or a tank holding compressed air. Where the earth-moving implement 10 is configured for attachment to a prime mover, the air compressor may be located on the prime mover. Connection to the air compressor may be made through airlines also providing air to air brakes on the earth moving apparatus 10 (which may be through a system including a compressed air reservoir tank). Where the earth moving apparatus 10 is a self-propelled implement, an air compressor located thereon and powered by an onboard engine may provide the gas to the airbag 106.

It will be appreciated that a skidplate assembly, including one or more skidplates 100, one or more pneumatic airbags 106, and any attachment or inflation components may be made available as an assembly for installation (such as aftermarket installation) on pre-existing earth-moving vehicles.

FIG. 3 depicts a schematic of a control system for utilizing a pneumatically activated skidplate system in accordance with the present invention. While reference is made to numerals in FIGS. 1 and 2 for clarity, it will be appreciated that other embodiments of pneumatically operated skidplate systems in accordance with the present invention are contemplated and considered within the scope of the present invention.

One or more sensors 200 may be disposed on the earth moving vehicle. These sensors may be motion sensors, such as electronic vibration sensors. In one illustrative embodiment, at least two vibration sensors may be used located opposite one another on the left and right sides of the earth mover 10. Such sensors may provide output in the form of electrical signal that may be digitally read by a computer to determine the frequency or amplitude of vibrations. During use, a control unit 202, such as an onboard computer system, monitors the vibrations reported by the sensor(s) 200. When the vibrations reported by the sensor are above a predetermined level, the control unit actuates the valve or valves 124 to inflate the airbag 106, moving the skidplate into a lowered position contacting the ground surface.

In this way, the occurrence of bounce can be reduced for the earth mover 10. The control unit 202 may be adjusted so that the level of vibration reported by the sensor 200 which causes the control unit 202 to actuate the airbags 106 at the onset of bounce or prior to the onset of bounce. It will be appreciated that the control system 202 may be further configured to deflate the airbags 106, upon the sensors reporting the drop of the monitored vibrations below another predetermined level, which may be done by actuating the valves 124 to exhaust gas from the airbags. Alternatively, the control unit 202 may report the actuation of the skidplate to the operator of the earth mover 10 and require the operator to deflate the airbags or discontinue use. It will be appreciated that the control unit may inflate and deflate the airbags to “cycle” or repeatedly contact the skidplate to the ground then retract it therefrom, in order to reduce bounce while minimizing wear on the skidplate and drag on the earth-moving vehicle.

Other sensors 200 may include hydraulic pressure sensors which monitor the hydraulic pressure in the hydraulic system of the earth mover 10. For example, two hydraulic pressure sensors 200 may be located opposite one another on the left and right sides of the earth mover 10 and monitor differences in hydraulic pressure at the opposite sides of the earth mover 10. Pressure spikes across the hydraulic system that are generally in opposition to one another could indicate the onset of bounce. The control system 202 may respond by inflating the airbags to deploy the skidplate.

While this invention has been described in certain illustrative embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system of stabilizing an earth-moving apparatus, the system comprising:
at least one skidplate; and
at least one pneumatic airbag attaching the skidplate to the earth-moving apparatus, such that the skidplate is lowered into contact with the ground upon inflation of the at least one pneumatic airbag.

2. The system of claim 1, wherein the earth moving apparatus comprises an earth-moving scraper.

3. The system of claim 2, wherein the least one skidplate is mounted behind a cutting blade of the earth-moving scraper.

4. The system of claim 3, wherein the at least one skidplate comprises a single skidplate extending substantially across a width equivalent to that of the earth-moving scraper blade.

5. The system of claim 1, wherein the at least one skidplate comprises at least two skidplates, each attached to the earth-moving apparatus by a separate pneumatic airbag.

6. The system of claim 1, wherein the at least one skidplate has a generally ski-shaped cross-section with an upturned front edge.

7. The system of claim 1, wherein the at least one pneumatic airbag comprises a sleeve-type airspring, a bellows-type airspring, a convoluted-type airspring, or a rolling lobe airspring.

8. The system of claim 7, further comprising a protective structure encasing the at least one pneumatic airbag.

9. The system of claim 8, wherein the protective structure encasing the at least one pneumatic airbag comprises a first ring attached to the at least one skidplate, encircling a bottom base of the at least one pneumatic airbag, and a second ring attached to the earth-moving apparatus, encircling a top base of the at least one pneumatic airbag, the first ring and the second ring concentrically disposed slidably adjacent to one another around the at least one pneumatic airbag.

10. The system of claim 1, further comprising:
at least one sensor for sensing vibration of the earth-moving apparatus; and
a control unit configured to monitor the at least one vibration sensor for the level of vibration and to inflate the at least one pneumatic airbag in response to a predetermined level of vibration.

11. A method of reducing bounce in a loading soil into an earth-moving apparatus, the method comprising:
inflating at least one pneumatic airbag attached to a skidplate of an earth-moving apparatus, thereby lowering the skidplate into contact with ground.

12. The method according to claim 11, further comprising:
monitoring vibration of the earth-moving apparatus to sense the beginning of bounce and inflating the at least one pneumatic airbag upon vibration of the earth-moving apparatus reaching a predetermined level.

13. The method according to claim 12, wherein monitoring vibration of the earth-moving apparatus to sense the beginning of bounce is accomplished using at least one vibration sensor disposed on the earth-moving apparatus.

14. The method according to claim 13, wherein monitoring vibration of the earth-moving apparatus is accomplished using a control unit to monitor the at least one vibration sensor and to inflate the at least one pneumatic airbag.

15. The method according to claim 11, wherein the earth moving apparatus comprises an earth-moving scraper.

16. The method according to claim 15, wherein the skidplate is mounted behind a cutting blade of the earth-moving scraper.

17. The method according to claim 11, wherein inflating at least one pneumatic airbag comprises inflating at least one pneumatic airbag selected from the group comprising a sleeve-type airspring, a bellows-type airspring, a convoluted-type airspring, and a rolling lobe airspring.

18. The method according to claim 11, further comprising:
monitoring vibration of the earth-moving apparatus to sense the end of bounce and deflating the at least one pneumatic airbag in response thereto.

19. A skidplate assembly for an earth-moving apparatus, comprising:
a skidplate; and
at least one pneumatic airbag disposed on the skidplate for attaching the skidplate to an earth-moving apparatus, configured to lower the skidplate into contact with the ground upon inflation of the at least one pneumatic airbag upon attachment to the earth-moving apparatus.

20. The skidplate assembly of claim 19, wherein at least one pneumatic airbag disposed on the skidplate for attaching the skidplate to an earth-moving apparatus is configured for mounting the skidplate behind a cutting blade of an earth-moving scraper.

21. The skidplate assembly of claim 19, wherein the skidplate has a generally ski-shaped cross-section with an upturned front edge.

22. The skidplate assembly of claim 19, wherein the at least one pneumatic airbag comprises a sleeve-type airspring, a bellows-type airspring, a convoluted-type airspring, or a rolling lobe airspring.

23. The skidplate assembly of claim 19, further comprising a protective structure encasing the at least one pneumatic airbag.

24. The system of claim 23, wherein the protective structure encasing the at least one pneumatic airbag comprises a first ring attached to the skidplate, encircling a bottom base of the at least one pneumatic airbag, and a second ring configured to attach to the earth-moving apparatus, encircling a top base of the at least one pneumatic airbag, the first ring and the second ring concentrically disposed slidably adjacent to one another around the at least one pneumatic airbag.
